(19) United States
(12) Patent Application Publication
(10) Pub. No.: US 2025/0016804 A1
(43) Pub. Date: Jan. 9, 2025

(54) USER EQUIPMENT AND INTER-UE COORDINATION METHOD PERFOMED THEREIN

(71) Applicant: Telefonaktiebolaget LM Ericsson (publ), Stockholm (SE)

(72) Inventors: Ricardo Blasco Serrano, Espoo (FI); Shehzad Ali Ashraf, Munich (DE); Jose Angel Leon Calvo, Munich (DE)

(21) Appl. No.: 18/705,683

(22) PCT Filed: Nov. 4, 2022
(86) PCT No.: PCT/SE2022/051013

§ 371 Date: Apr. 29, 2024

Related U.S. Application Data
(60) Provisional application No. 63/276,175, filed on Nov. 5, 2021.

(51) Int. Cl. H04W 72/40; H04W 92/18

(52) U.S. Cl. CPC H04W 72/40; H04W 92/18

(57) ABSTRACT

The present disclosure provides a first user equipment, a second user equipment and inter-UE coordination methods performed by the first and second user equipment. The inter-UE coordination method performed by a first User Equipment, UE, for autonomous resource allocation for sidelink transmission comprises: receiving, from a second UE, a message that indicates one or more resources reserved for a future sidelink transmission by the second UE; determining that a triggering condition for transmission of an inter-UE coordination message is satisfied, based on the received message; and either transmitting the inter-UE coordination message or refraining from transmitting the inter-UE coordination message, based on one or more rules for determining whether to transmit the inter-UE coordination message.

### TECHNICAL FIELD

The present disclosure relates to wireless communications, and in particular, to a first user equipment, a second user equipment, and inter-UE coordination methods performed by the first and second user equipment.

### BACKGROUND

The 3^{rd} Generation Partnership Project (3GPP) specified support in Long Term Evolution (LTE) for PROximity SErvices (ProSe) in Releases 12 and 13, targeting public safety use cases (e.g., first responders) as well as a small subset of commercial use cases (e.g., discovery). The main novelty of ProSe was the introduction of Device-to-Device (D2D) communications using the sidelink (SL) interface. During Rel-14 and Rel-15 in 3GPP, major changes were introduced to the LTE SL framework with the aim of supporting Vehicle-to-Everything/Anything (V2X) communications, where V2X collectively denotes communication between vehicle to any other endpoint (e.g., a vehicle, a pedestrian, etc.). The feature targeted mostly basic V2X use cases such as day-1 safety, etc.

During Rel-16, 3GPP worked on specifying the sidelink interface for Fifth Generation (5G) New Radio (NR). The NR sidelink in Rel-16 mainly targeted advanced V2X services, which can be categorized into four use case (UC) groups: vehicles platooning, extended sensors, advanced driving, and remote driving. Supporting the advanced V2X services required a new sidelink design in order to meet the stringent requirements in terms of latency and reliability. The NR sidelink in Rel-16 was designed to provide higher system capacity, increased reliability, and better coverage. In addition, the design considered the possibility of having future extensions to support further advanced V2X services and other related services.

The radio layers in LTE SL supported only broadcast communications. In contrast, the NR SL includes support in the radio layers for broadcast, multicast, and unicast communications. For example, in the platooning service, there are certain messages that are only of interest to the members of the platoon, making the members of the platoon a group. In another example, the see-through use case most likely involves only a pair of vehicles, for which unicast transmissions naturally fit. Like in LTE sidelink, the NR sidelink is designed in such a way that its operation is possible with and without network coverage and with varying degrees of interaction between the User Equipments (UEs) and the network (NW), including support for standalone, network-less operation.

3GPP usually refers to D2D transmissions as sidelink transmissions or transmissions using the PC5 interface.

In regard to resource allocation for sidelink transmissions, the 3GPP specifications define two resource allocation modes for NR sidelink:
Network-based resource allocation, in which the network selects the resources and other transmit parameters used by sidelink UEs. In some cases, the network may control every single transmission parameter. In other cases, the network may select the resources used for transmission but may give the transmitter the freedom to select some of the transmission parameters, possibly with some restrictions. In the context of NR SL, 3GPP refers to this resource allocation mode as Mode 1.
Autonomous resource allocation, in which the UEs autonomously select the resources and other transmit parameters. In this mode, there may be no intervention by the network (e.g., out of coverage, unlicensed carriers without a network deployment, etc.) or very minimal intervention by the network (e.g., configuration of pools of resources, etc.). In the context of NR SL, 3GPP refers to this resource allocation mode as Mode 2.

Note that NR SL resource allocation Mode 1 and Mode 2 are the respective counterparts of Mode 3 and Mode 4 in LTE SL. Also note that NR SL resource allocation Mode 2 is also referred to herein as “NR SL transmission Mode 2”, “Transmission Mode 2”, and simply “Mode 2”.

In NR SL transmission Mode 2, distributed resource selection is employed, i.e., there is no central node for scheduling and resources are autonomous selected by the UEs. Transmission Mode 2 is based on two functionalities: reservation of future resources and sensing-based resource allocation. Reservation of future resources is done so that the UE sending a message also notifies the receivers about its intention to transmit using certain time-frequency resources at a later point in time. For example, a UE transmitting at time T informs the receivers that it will transmit using the same frequency resources at time T+100 milliseconds (ms). Resource reservation allows a receiving UE to predict the utilization of the radio resources in the future. That is, by listening to the current transmissions of another UE, it also obtains information about potential future transmissions. This information can be used by the UE to avoid collisions when selecting its own resources. Specifically, a UE predicts the future utilization of the radio resources by reading received booking messages and then schedules its current transmission to avoid using the same resources. This is known as sensing-based resource selection.

The sensing-based resource selection scheme specified in NR Rel-16 can be roughly summarized in the following steps and is defined in Clause 8.1.4 in 3GPP Technical Specification (TS) 38.214 (see, e.g., V16.7.0).
a) A UE senses the transmission medium during an interval [n-a, n-b], where n is a time reference, and a>b≥0) define the duration of the sensing window. The length of the sensing window is (pre-) configurable.
b) Based on the sensing results, the UE predicts the future utilization of the transmission medium at a future time interval [n+T1, n+T2], where T2>T1≥0. The interval [n+T1, n+T2] is the resource selection window.
c) The UE selects one or more time-frequency resources among the resources in the selection window [n+T1, n+T2] that are predicted/determined to be selectable (e.g., idle, usable, available, etc.).

The UE may select resources for one or more transmissions of a same Transport Block (TB) in this way. In addition, if the UE expects to perform periodic or quasi periodic transmissions, it can select resources for transmissions of multiple TBs too. When this latter mechanism is used, the resources are selected in a periodic manner. That is, if the frequency resource R at time n is selected for the first transmission, then the frequency resource R at time n+P is selected for the second transmission. Similarly, the frequency resource R at time n+2P is selected for the third transmission, if applicable; and so on. Note that resource selection is an internal procedure to the UE. That is, a second UE is not aware of the resources selected by the first UE unless the first UE reserves the selected resources using the mechanism described below. FIG. 1 illustrates an example of periodic transmissions with time interval P. Note that the first transmission of TB1 reserves two resources for retransmissions of TB1 and three resources for transmission of TB2 (after time interval P). In contrast, the first transmission of TB2 only reserves two resources for retransmissions of TB2; no resources for transmissions of another TB are reserved since P=0 is signaled.

In Rel-17, 3GPP is working on multiple enhancements for the sidelink with the aim of extending the support for V2X and to cover other use cases (UCs) such as public safety (see RP-202846). Among these, one enhancement targets improving the performance using inter-UE resource coordination. Table 1 below includes the objective in the work item description for SL enhancement that is relevant for the present disclosure emphasized with bold, underlined text.

TABLE 1
Relevant objective in the Rel-17 work item on sidelink enhancements.

2. Resource allocation enhancement:

| | [...] | |
|---|---|---|
| ● | Study the feasibility and benefit of solution(s) on the enhancement(s) in mode 2 for | |
| | enhanced reliability and reduced latency in consideration of both PRR and PIR | |
| | defined in TR37.885 (by RAN#91), and specify the identified solution(s) if deemed | |
| | feasible and beneficial [RAN1, RAN2] | |
| | ▪ | Inter-UE coordination with the following. |

| | |
|---|---|
| ♦ | A set of resources is determined at UE-A. This set is sent to UE-B in |

mode 2, and UE-B takes this into account in the resource selection for
its own transmission.

| ▪ | Note: The solution should be able to operate in-coverage, partial coverage, and |
|---|---|
| | out-of-coverage and to address consecutive packet loss in all coverage |
| | scenarios. |
| ▪ | Note: RAN2 work will start after RAN#89. |

The specification work is still under discussion, and the work is in progress. Nevertheless, some agreements which are related to the present disclosure are the following as captured in Table 2.

TABLE 2
Relevant agreements on inter-UE coordination

Agreement:

| | |
|---|---|
| • | Support the following schemes of inter-UE coordination in Mode 2: |

| | |
|---|---|
| - | Inter-UE Coordination Scheme 1: |

| | |
|---|---|
| • | The coordination information sent from UE-A to UE-B is the set of |

| resources preferred and/or non-preferred for UE-B's transmission | |
|---|---|
| ✓ | FFS details including a possibility of down-selection between the |

preferred resource set and the non-preferred resource set, whether or not
to include any additional information other than indicating
time/frequency of the resources within the set in the coordination
information

| | |
|---|---|
| • | FFS condition(s) in which Scheme 1 is used |

| | |
|---|---|
| - | Inter-UE Coordination Scheme 2: |

| | |
|---|---|
| • | The coordination information sent from UE-A to UE-B is the presence of |

| expected/potential and/or detected resource conflict on the resources | |
|---|---|
| indicated by UE-B's SCI | |
| ✓ | FFS details including a possibility of down-selection between the |

expected/potential conflict and the detected resource conflict

| | |
|---|---|
| • | FFS condition(s) in which Scheme 2 is used |

Agreement
For scheme 2, the following inter-UE coordination information signalling from UE-A is
supported. FFS details including condition(s)/scenario(s) under which each information is
enabled to be sent by UE-A and used by UE-B

| | |
|---|---|
| • | Presence of expected/potential resource conflict on the resources indicated by UE- |

B's SCI

| | |
|---|---|
| ∘ | FFS: UE behaviour when the presence of expected/potential resource conflict |

is detected by the transmitter

| | |
|---|---|
| • | FFS: Whether to additionally support the presence of detected resource conflict on |

the resources indicated by UE-B's SCI

Agreement
In scheme 2, at least the following is supported for UE(s) to be UE-A(s)/UE-B(s) in the inter-
UE coordination transmission triggered by a detection of expected/potential resource
conflict(s) in Mode 2:

| • | A UE that transmitted PSCCH/PSSCH with SCI indicating reserved resource(s) to be |
|---|---|
| | used for its transmission, received inter-UE coordination information from UE-A |
| | indicating expected/potential resource conflict(s) for the reserved resource(s), and |
| | uses it to determine resource re-selection is UE-B |
| • | A UE that detects expected/potential resource conflict(s) on resource(s) indicated by |

UE-B's SCI sends inter-UE coordination information to UE-B, subject to satisfy one
of the following conditions, is UE-A

| | |
|---|---|
| ∘ | Working assumption At least a destination UE of one of the conflicting TBs, |

i.e., TBs to be transmitted in the expected/potential conflicting resource(s)

| | |
|---|---|
| • | Whether a non-destination UE of a TB transmitted by UE-B can be |

UE-A is (pre-)configured

| | |
|---|---|
| ∘ | FFS: Additional details and condition(s) on UE-A and UE-B |

| | |
|---|---|
| • | The above feature can be enabled or disabled or controlled by (pre-)configuration |

| | |
|---|---|
| ∘ | FFS: Details on how to support this, including (pre-)configuration signaling |

granularity

| | |
|---|---|
| • | FFS: Definition of expected/potential resource conflict(s) and other details (if any) |

Agreement
In scheme 2, the following UE-B's behavior in its resource (re)selection is supported when
it receives inter-UE coordination information from UE-A:

| | |
|---|---|
| • | UE-B can determine resource(s) to be re-selected based on the received coordination |
| | information |

| | |
|---|---|
| ∘ | UE-B can reselect resource(s) reserved for its transmission when |

expected/potential resource conflict on the resource(s) is indicated

| | |
|---|---|
| • | FFS: Other details (if any) |

Agreement
In scheme 2, at least the following is supported to determine inter-UE coordination
information:

| | |
|---|---|
| - | Among resource(s) indicated by UE-B's SCI, UE-A considers that |

| expected/potential resource conflict occurs on the resource(s) satisfying at least one | |
|---|---|
| of the following condition(s): | |
| • | Condition 2-A-1: |

| ∘ | Other UE's reserved resource(s) identified by UE-A are fully/partially |
|---|---|
| | overlapping with resource(s) indicated by UE-B's SCI in time-and- |
| | frequency |
| ∘ | FFS: Other details (if any) |
| ∘ | FFS: Whether/how to specify additional criteria and other details (if any) |

including signaling details of conflict indication

| | |
|---|---|
| • | (Working Assumption) Condition 2-A-2: |

| | |
|---|---|
| ∘ | Resource(s) (e.g., slot(s)) where UE-A, when it is intended receiver of UE- |

| B, does not expect to perform SL reception from UE-B due to half duplex | |
|---|---|
| operation | |
| ✓ | FFS: Other details (if any) |

| | |
|---|---|
| - | FFS: Other condition(s) |

| | |
|---|---|
| - | FFS: Other details (if any) |

Agreement
For Scheme 2, PSFCH format 0 is used to convey the presence of expected/potential resource
conflict on reserved resource(s) indicated by UE-B's SCI
Agreement
For Condition 2-A-1 of Scheme 2, down-select one or more of following additional criteria
to determine resource(s) where expected/potential resource conflict occurs

| | |
|---|---|
| • | Option 1: The resource(s) are fully/partially overlapping in time-and-frequency with |

| other UE's reserved resource(s) whose RSRP measurement is larger than a RSRP | |
|---|---|
| threshold according to the priorities included in the SCI: | |
| - | prio_TX and prio_RX are the priorities indicated in the SCI making the |
| | overlapping reservations |
| - | Strive to reuse Rel-16 specification wherever possible |

| | |
|---|---|
| • | Option 2: The resource(s) are fully/partially overlapping in time-and-frequency with |

| other UE's reserved resource(s) whose RSRP measurement is within a | |
|---|---|
| (pre)configured RSRP threshold compared to the RSRP measurement of UE-B's | |
| reserved resource. | |
| - | FFS: Whether the threshold depends on priority |

| • | Option 3: The resource(s) are fully/partially overlapping in time-and-frequency with |
|---|---|
| | other UE's reserved resource(s) and the other UE is within a distance threshold of |
| | UE-B as determined by both UEs' SCIs. |
| • | Option 4: The resource(s) are fully/partially overlapping in time-and-frequency with |

| other UE's reserved resource(s) whose RSRP measurement is larger a | |
|---|---|
| (pre)configured RSRP threshold compared to the RSRP measurement of UE-B's | |
| reserved resource. | |
| - | FFS: Whether the threshold depends on priority |

| | |
|---|---|
| • | FFS: In case of collisions of resources for two UEs having TBs with UE A as |

destination UE, if needed

Agreement
For allocating PSFCH resources in Scheme 2, at least following can be (pre)configured
separately from those for SL HARQ-ACK feedback.

| | |
|---|---|
| • | Set of PRBs for PSFCH transmission/reception (sl-PSFCH-RB-Set) |

Agreement
For Scheme 2,

| | |
|---|---|
| • | Index of a PSFCH resource for inter-UE coordination information transmission is |

| determined in the same way according to Rel-16 TS 38.213 Section 16.3 with at least | |
|---|---|
| following modification | |
| - | P_ID is L1-Source ID indicated by UE-B's SCI |
| - | M_ID is 0 |

| | |
|---|---|
| • | FFS: How to set m_CS |
| • | FFS: How to set m_0 |
| • | FFS: Whether M_ID can be (pre)configured |

The purpose of inter-UE coordination is to enhance the Mode 2 resource allocation procedure by having UEs convey some results related to sensing to other UEs. The principle of operation of Scheme 2 is the following:
A first UE (referred to as UE-B in the above agreements in Table 2), performs a sidelink transmission that indicates a reservation of a future resource for a future sidelink transmission. The reservation is indicated in a Sidelink Control Information (SCI).
A second UE (referred to as UE-A in the above agreements in Table 2) receives the SCI transmitted by UE-B and determines that the resource reserved by UE-B is subject to a conflict. The conflict may correspond to:
   The resource reserved by UE-B has been previously reserved by a third UE and the reservation of the third UE has higher or equal priority than that of UE-B (e.g., as indicated in the SCI; or the reservation performed by UE-B cannot pre-empt that of the third UE). This corresponds to Condition 2-A-1 in the agreement in Table 2 and is illustrated in FIG. 2. FIG. 2 is an illustration of an example of inter-UE coordination Scheme 2. In this example, the inter-UE coordination message is transmitted by UE-A after detecting that a newly received reservation from UE-B conflicts with a reservation from UE3 received earlier.
   The resource reserved by UE-B is for a transmission to UE-A. However, UE-A determines that it will not be able to receive the transmission from UE (e.g., due to the need to perform a transmission of its own, due to a Discontinuous Reception (DRX) cycle, etc.). This corresponds to Condition 2-A-2 in the agreement in Table 2 above and is illustrated in FIG. 3. Specifically, FIG. 3 is an illustration of an example of Inter-UE coordination scheme 2. In this example, the inter-UE coordination message is transmitted by UE-A after detecting that UE-B intends to transmit to UE-B at a future time when UE-A expects not to be able to receive the transmission from UE-B.
The second UE transmits a coordination message (sometimes referred to as inter-UE coordination message or IUC message) to the first UE. The message indicates the conflict situation and triggers the first UE to reselect resources.

In Scheme 2, the inter-UE coordination message is transmitted using a sequence-based channel (e.g., Physical Sidelink Feedback Channel, PSFCH). This channel can only carry a small number of bits (typically 1 or 2 bits). Thus, to allow the receiver of the coordination message (i.e., UE-B) to determine which reservation is in conflict, some additional information is signaled in an implicit manner. Two options are currently being considered:
Option 1. A resource (e.g., sub-channel) carrying the SCI that allows UE-A to detect the conflict determines the resource (e.g., PSFCH resource) that is used for transmitting the IUC message. Thus, after sending an SCI carrying a reservation, UE-B knows where to expect a IUC message (if any is transmitted). This is illustrated in FIG. 4. In other words, in the example of FIG. 4, the resource used by UE-B for transmitting the SCI reserves a resource in the future. The resource used by UE-B for transmitting the SCI determines the resource to be used for transmission of a IUC message by UE-A, if necessary.
Option 2. The resource (e.g., PSFCH resource) used for transmitting the IUC message is determined from a resource (e.g., a sub-channel) on which a collision is expected (e.g., a sub-channel). This is illustrated in FIG. 5. In other words, in the example of FIG. 5, the resource used by UE-B for transmitting the SCI reserves a resource in the future. The resource reserved by the SCI determines the resource to be used for transmission of a IUC message by UE-A, if necessary.

### SUMMARY

It is an object of embodiments described herein to address at least some of the problems and issues outlined above. More particularly it is an object to provide methods and nodes to perform inter-UE coordination.

A first aspect of the disclosed technology relates to an inter-UE coordination method performed by a first User Equipment, UE, (602-A), for autonomous resource allocation for sidelink transmission. The method comprises: receiving (1000), from a second UE (602-B), a message that indicates one or more resources reserved for a future sidelink transmission by the second UE (602-B); determining (1002) that a triggering condition for transmission of an inter-UE coordination message is satisfied, based on the received message; and either transmitting (1006) the inter-UE coordination message or refraining (1008) from transmitting the inter-UE coordination message, based on one or more rules for determining whether to transmit the inter-UE coordination message.

A second aspect of the disclosed technology relates to an inter-UE coordination method performed by a second User Equipment, UE, (602-B) for autonomous resource allocation for sidelink transmission. The method comprises: transmitting (1000), to a first UE (602-A), a message that indicates one or more resources reserved for a future sidelink transmission by the second UE (602-B); and either monitoring (1010) for an inter-UE coordination message or refraining (1012) from monitoring for the inter-UE coordination message, based on one or more rules for determining whether to monitor for the inter-UE coordination message.

A third aspect of the disclosed technology relates to a first user equipment, UE, (602-A). The first UE (602-A) is configured to: receive, from a second UE (602-B), a message that indicates one or more resources reserved for a future sidelink transmission by the second UE (602-B); determine that a triggering condition for transmission of an inter-UE coordination message is satisfied, based on the received message; and either transmit the inter-UE coordination message or refrain from transmitting the inter-UE coordination message, based on one or more rules for determining whether to transmit the inter-UE coordination message.

A fourth aspect of the disclosed technology relates to a second user equipment, UE, (602-B). The second UE (602-B) is configured to: transmit, to a first UE (602-A), a message that indicates one or more resources reserved for a future sidelink transmission by the second UE (602-B); and either monitor for an inter-UE coordination message or refrain from monitoring for the inter-UE coordination message, based on one or more rules for determining whether to monitor for the inter-UE coordination message.

Certain embodiments may provide one or more of the following technical advantages. One technical advantage of embodiments may be that they provide solutions that provide enough preparation time to the transmitter. Another technical advantage of embodiments may be that they provide enough processing time to the receiver to be able to benefit from the inter-UE coordination information.

These and other objects, features and advantages of the exemplary embodiments of the present disclosure will become apparent upon reading the following detailed description of the exemplary embodiments of the present disclosure.

### BRIEF DESCRIPTION OF THE DRAWINGS

Embodiments will now be described in more detail in relation to the enclosed drawings, in which:

FIG. 1 illustrates an example of periodic transmissions with time interval P.

FIG. 2 is an illustration of an example of inter-UE coordination Scheme 2.

FIG. 3 is an illustration of an example of Inter-UE coordination scheme 2.

FIG. 4 illustrates an example of determining the resource to be used for transmission of a IUC message.

FIG. 5 illustrates another example of determining the resource to be used for transmission of a IUC message.

FIG. 6 illustrates one example of a system 600 in which embodiments of the present disclosure may be implemented.

FIG. 7 illustrates a scheme where the resource used for transmitting the inter-UE coordination message is derived based on the slot/resources where the information used to determine an expected collision is transmitted.

FIG. 8 illustrates a scheme where the resource used for transmitting the inter-UE coordination message is derived based on the slot/resources where the information used to determine an expected collision is transmitted.

FIG. 9 illustrates a scheme where the resource used for transmitting the inter-UE coordination message is derived based on the slot/resources where the collision is expected to occur.

FIG. 10A illustrates the operation of the first UE 602-A and the second UE 602-B in accordance with one example embodiment of the present disclosure.

FIG. 10B illustrates the operation of the first UE 602-A in accordance with one example embodiment of the present disclosure.

FIG. 10C illustrates the operation of the second UE 602-B in accordance with one example embodiment of the present disclosure.

FIG. 11 shows an example of a communication system 1100 in accordance with some embodiments.

FIG. 12 shows a UE 1200 in accordance with some embodiments.

FIG. 13 shows a network node 1300 in accordance with some embodiments.

FIG. 14 is a block diagram of a host 1400 in accordance with some embodiments.

FIG. 15 is a block diagram illustrating a virtualization environment 1500 in which functions implemented by some embodiments may be virtualized.

FIG. 16 shows a communication diagram of a host 1602 communicating via a network node 1604 with a UE 1606 over a partially wireless connection in accordance with some embodiments.

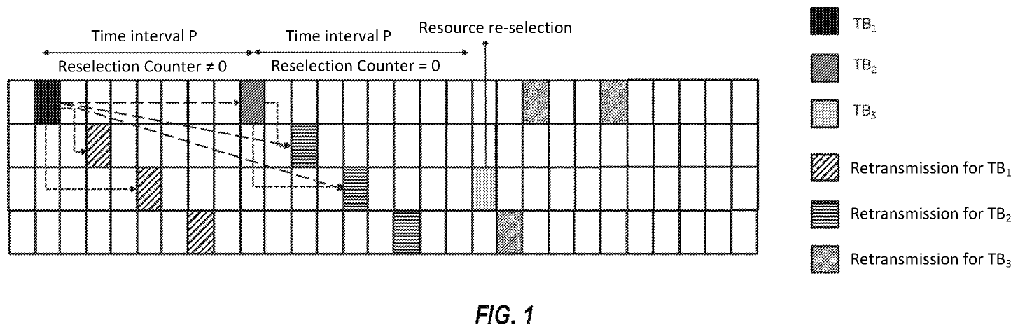

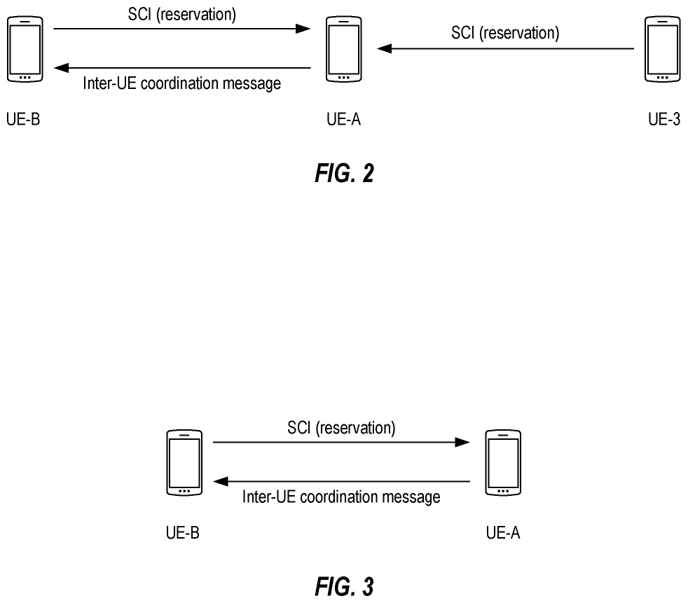

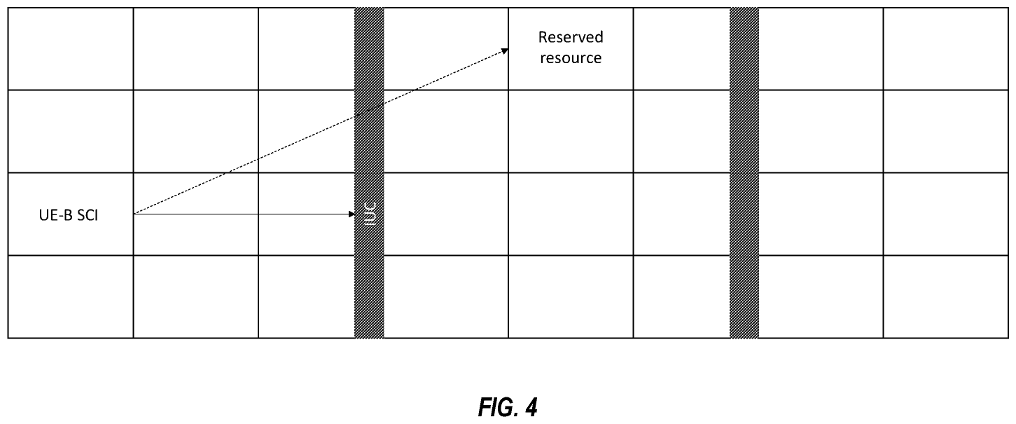

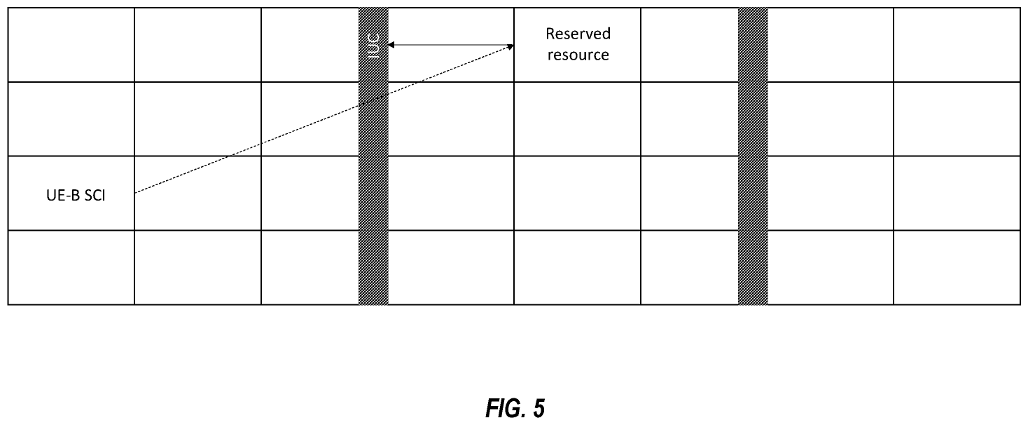

### DETAILED DESCRIPTION

There currently exist certain challenge(s). One problem is that, in some cases, the inter-UE coordination message transmitted upon fulfillment of a condition (e.g., a collision is detected, or the unavailability of a receiver is determined) may be transmitted too late for its receiver to be able to make use of it. Another problem is that, in some cases, the opportunity for transmitting an inter-UE coordination message may not be suitable for the transmitter as it may require a very short preparation time.

The present disclosure is mostly related with operations and methods using resource allocation Mode 2 or any other mode in which the UE(s) perform sensing and resource allocation. The present disclosure is mostly related to Scheme 2 as defined in the previous agreements (Table 2). However, the present disclosure is not limited to NR sidelinks and may be used for other types of sidelinks using autonomous resource allocation by the UEs and inter-UE coordination.

Certain aspects of the disclosure and their embodiments may provide solutions to these or other challenges. Systems and methods are disclosed herein for determining when or whether to transmit an inter-UE coordination message upon fulfillment of a condition (e.g., a collision is detected, or the unavailability of a receiver is determined) based on one or more rules. In one embodiment, the one or more rules used to determine when or whether to transmit the inter-UE coordination message upon fulfillment of a condition (e.g., a collision is detected, or the unavailability of a receiver is determined) are based on one or more of the following parameters:
a time when a triggering condition for transmitting the inter-UE coordination message is detected,
a time (in the future) when a potential collision between transmissions is determined or is expected to take place,
a time when the inter-UE coordination message is transmitted or can be transmitted,
a time when the inter-UE coordination message is received or can be received;
a preparation time (i.e., the time that it takes for the UE transmitting the inter-UE coordination message to prepare the IUC message),
a time when the resource reservation message (e.g., SCI) is received by the UE transmitting the inter-UE coordination message,
a time at which the resource reservation message (e.g., SCI) to the UE transmitting the inter-UE coordination message was transmitted;
a processing time (i.e., the time that it takes for the UE receiving the inter-UE coordination message to decode the IUC message and/or to apply the desired action based on the IUC message).
a processing time (e.g., the time that it takes for the UE receiving the resource reservation message (e.g., SCI) to decode the message and/or to determine that an expected/potential resource conflict is to occur on reserved resource(s)).

Certain embodiments may provide one or more of the following technical advantage(s). Embodiments of the present disclosure may ensure that the inter-UE coordination messaging procedure:
provides enough preparation time to the transmitter, and/or
provides enough processing time to the receiver to be able to benefit from the inter-UE coordination information.

Some of the embodiments contemplated herein will now be described more fully with reference to the accompanying drawings. Embodiments are provided by way of example to convey the scope of the subject matter to those skilled in the art. Additional information may also be found in the document(s) provided in the Appendix.

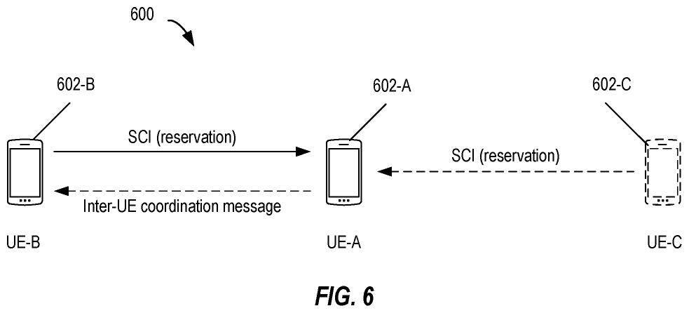

FIG. 6 illustrates one example of a system 600 in which embodiments of the present disclosure may be implemented. The system 600 includes a first User Equipment (UE) 602-A, a second UE 602-B, and optionally a third UE 602-C that communicate via respective sidelinks. In one embodiment, the sidelinks are NR sidelinks and, more specifically, NR sidelinks using resource allocation Mode 2 (i.e., autonomous resource allocation) and inter-UE coordination scheme 2. However, the present disclosure is not limited to NR sidelinks and may be used for other types of sidelinks using autonomous resource allocation by the UEs and inter-UE coordination.

In accordance with embodiments of the present disclosure, when or whether an inter-UE coordination message is transmitted from the first UE 602-A to the second UE 602-B upon fulfillment of a condition (e.g., a collision is detected, or the unavailability of a receiver at the second UE 602-B is determined) is determined based on one or more rules. The one or more rules are based upon one or more of the following parameters:
(a) a time when a triggering condition for transmitting the inter-UE coordination message is detected,
(b) a time (in the future) when a potential collision between transmissions (e.g., a collision between a scheduled transmission from the second UE 602-B and another scheduled transmission from the third UE 602-C) is determined or is expected to take place,
(c) a time when the inter-UE coordination message is transmitted or can be transmitted,
(d) a preparation time (i.e., the time that it takes for the first UE 602-A transmitting the inter-UE coordination message to prepare the inter-UE coordination message),
(e) a processing time (i.e., the time that it takes for the second UE 602-B receiving the inter-UE coordination message to decode the inter-UE coordination message and/or to apply a desired action based on the inter-UE coordination message),
(f) a time at which the resource reservation message (e.g., SCI) received from the second UE 602-B was received,
(g) a processing time for the first UE 602-A to process the received message (e.g., the time that it takes for the first UE 602-A receiving the SCI transmitted by the UE 602-B to decode the SCI and/or to determine that an expected/potential resource conflict is to occur on reserved resource(s) indicated by UE 602-B's SCI).
   Note that, as used herein, a “collision” is expected to occur or may take place when there are two (or more) reservations (e.g., by the second UE 602-B and the third UE 602-C) for the same (or overlapping) resource(s) for sidelink communication in the future. Thus, the collision may also be referred to herein as a resource reservation conflict. If the inter-UE coordination message is transmitted and processed successfully, the collision will actually not occur. In other words, if this potential conflict is resolved (e.g., by using an embodiment of the present disclosure), then there will be no actual collision between sidelink transmissions.

In some cases, bounds for the different times may be used. For example:
instead of a processing/preparation time, a maximum allowed time defined, e.g., in the 3GPP specifications for that purpose may be used,
instead of the time when the inter-UE coordination message is transmitted or can be transmitted, the worst case that can be found with a given configuration may be used. For example, in with some configurations a resource for transmitting an inter-UE coordination message may only appear every 4 slots. Thus, the inter-UE coordination message may be transmitted 1-4 slots after the slot in which the UE 602-A determines that it has to transmit the inter-UE coordination message. Rather than using the actual value, a bound (e.g., 4) may be used.

In some cases, functions of the times may be used. For example, a difference between two times or a sum of two times.

Some example rules that may be used at the first UE 602-A for determining whether to transmit the inter-UE coordination message are given in the list below. However, these are only examples. These rules reference the times listed above in (a)-(f) as “time (a)”, “time (b)”, etc.
a rule that is based on time (b) minus time (e) or a lower bound of time (b) minus time (e) (e.g., a bound Y such that Y<time (b)−time (e)),
   This rule is relevant for Option 1.
a rule that is based on a comparison of a first time and a second time, wherein the first time is based on or equal to time (b) minus time (e) or a lower bound of time (b) minus time (e) and the second time is based on or equal to time (c),
   This rule is relevant for Option 1.
a rule that is based on a sum of time (g) and time (d) or a higher bound of the sum of time (g) and time (d) (e.g., a bound X such that X>time (g) plus time (d)),
   This rule is relevant for Option 2.
a rule that is based on a sum of time (a) and time (d) or a higher bound of the sum of time (a) and time (d) (e.g., a bound X such that X>time (a) plus time (d)),
   This rule is relevant for Option 2.
a rule that is based on a comparison of a first time and a second time, wherein the first time is based on or equal to a sum of time (g) and time (d) or a higher bound of the sum of time (g) and time (d) and the second time is based on or equal to time (c),
   This rule is relevant for Option 2.
a rule that is based on a comparison of a first time and a second time, wherein the first time is based on or equal to a sum of time (a) and time (d) or a higher bound of the sum of time (a) and time (d) and the second time is based on or equal to time (c).
   This rule is relevant for Option 2.

Some example rules that may be used at the second UE 602-B for determining whether to monitor for an inter-UE coordination message are given in the list below. However, these are only examples. These rules reference the times listed above in (a)-(f), but from the perspective of the second UE 602-B.
a rule that is based on time (b) minus time (e) or a lower bound of time (b) minus time (e) (e.g., a bound Y such that Y<time (b)−time (e)),
   This rule is relevant for Option 1.
a rule that is based on a comparison of a first time and a second time, wherein the first time is based on or equal to time (b) minus time (e) or a lower bound of time (b) minus time (e) and the second time is based on or equal to time (c),
   This rule is relevant for Option 1.
a rule that is based on a sum of time (g) and time (d) or a higher bound of the sum of time (g) and time (d) (e.g., a bound X such that X>time (g) plus time (d)),
   This rule is relevant for Option 2.
a rule that is based on a sum of time (a) and time (d) or a higher bound of the sum of time (a) and time (d) (e.g., a bound X such that X>time (a) plus time (d)),
   This rule is relevant for Option 2.
a rule that is based on a comparison of a first time and a second time, wherein the first time is based on or equal to a sum of time (g) and time (d) or a higher bound of the sum of time (g) and time (d) and the second time is based on or equal to time (c),
   This rule is relevant for Option 2.
a rule that is based on a comparison of a first time and a second time, wherein the first time is based on or equal to a sum of time (a) and time (d) or a higher bound of the sum of time (a) and time (d) and the second time is based on or equal to time (c).
   This rule is relevant for Option 2.

Note that embodiments of the present disclosure are described in terms of rules that determine when the first UE 602-A transmits an inter-UE coordination message. If the conditions are not met, the first UE 602-A does not transmit the inter-UE coordination message or it is not expected to transmit the inter-UE coordination message (i.e., higher performance UEs may transmit the inter-UE coordination message even if they are not expected to do it, whereas lower performance UEs may not transmit the inter-UE coordination message). For example,
A first condition for transmitting the inter-UE coordination message is detected (e.g., the first UE 602-A determines that a collision may take place in the future).
The first UE 602-A determines (using a rule(s) in accordance with an embodiment of the present disclosure) that the inter-UE coordination message can be transmitted.
The first UE 602-A triggers an IUC messaging procedure responsive to determining that the inter-UE coordination message can be transmitted. In other words, the first UE 602-A transmits the inter-UE coordination message responsive to determining that the inter-UE coordination message can be transmitted.

Note, however, that rules described herein for embodiments of the present disclosure may be transformed into rules that determine when a UE does not transmit an inter-UE coordination message (or when it is allowed not to transmit it). For example:
A first condition for transmitting the inter-UE coordination message is detected (e.g., the first UE 602-A determines that a collision may take place in the future).
The IUC messaging procedure is triggered at the first UE 602A.
As part of the IUC messaging procedure, the first UE 602A uses the rule(s) (e.g., based on the parameter(s) described herein) are used by the first UE 602-A to determine whether the inter-UE coordination message is transmitted or not. In some cases, the relationship between the times in the rule(s) is such that the first UE 602-A determines that it is to transmit the inter-UE coordination message. In other cases, the relationship between the times in the rule(s) is such that the first UE 602-A determines that it is not required to transmit the inter-UE coordination message (or it determines that it is not to transmit the inter-UE coordination message). In the former case, the inter-UE coordination message is transmitted. In the latter case, the inter-UE coordination message is dropped.

In accordance with embodiments of the present disclosure, when or whether an inter-UE coordination message is monitored and/or received by the second UE 602-B upon fulfillment of a condition (e.g., a collision is detected, or the unavailability of a receiver at the second UE 602-B is determined) is determined based on one or more rules. The one or more rules are based upon one or more of the following parameters:
(a) a time at which the triggering condition for transmission of the inter-UE coordination message was detected;
(b) a time when a potential collision between a first transmission by the second UE (602-B) and a second transmission by another UE (602-C) is expected to occur;
(c) a time when the inter-UE coordination message is received or can be received;
(d) a preparation time for preparing the inter-UE coordination message at the first UE (602-A);
(e) a processing time for processing the inter-UE coordination message at the second UE (602-B);
(f) a time at which the resource reservation message (e.g., SCI) from the second UE (602-B) to the first UE (602-A) was transmitted;
(g) a processing time for processing the transmitted message at the first UE (602-A) (e.g., the time that it takes for the first UE 602-A receiving the SCI transmitted by the UE 602-B to decode the SCI and/or to determine that an expected/potential resource conflict is to occur on reserved resource(s) indicated by UE 602-B's SCI).

Below, example rules for determining whether to transmit the inter-UE coordination message are described. In these examples, actions for the first UE 602-A and/or actions for the second UE 602-B are described.

### Example Rule 1: Solution for Option 1

In this part, example rules for determining whether to transmit the inter-UE coordination message for the case that the resource used for transmitting the inter-UE coordination message is determined from the resource carrying the information that allows a UE to determine that a collision is expected (i.e., Option 1 described in the Introduction section above for Scheme 2).

In regarding to the behavior of the first UE 602-A, for this rule, the first UE 602-A transmits the inter-UE coordination message if time of the resource on which the inter-UE coordination message is to be transmitted is less than the time of the resource on which a collision is expected minus the processing time (i.e., the time that it takes for the second UE 602-B receiving the inter-UE coordination message to decode the inter-UE coordination message and/or to apply a desired action based on the inter-UE coordination message). The rule for the first UE 602-A to transmit the inter-UE coordination message specifies that the time (c) when the inter-UE coordination message is to be transmitted must be before the time (b) when a collision between a first transmission by the second UE 602-B and a second transmission by another UE 602-C is expected to occur by at least the processing time (e) for processing the inter-UE coordination message at the second UE 602-B.

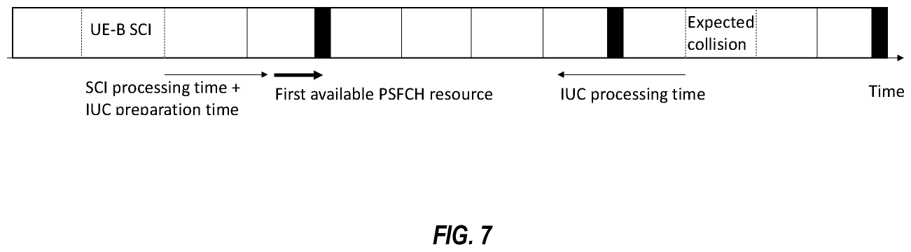

FIG. 7 illustrates a scheme where the resource used for transmitting the inter-UE coordination message, e.g., PSFCH resource, is derived based on the slot/resources where the information used to determine an expected collision, e.g., UE-B's SCI, is transmitted.

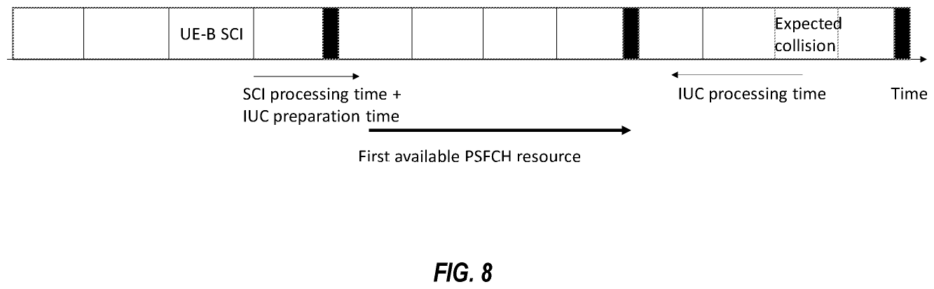

As described earlier, due to the preparation time, the inter-UE coordination message may have to be transmitted in a PSFCH resource other than the one that is immediately after the resource which carried the information that allowed the first UE 602-A to determine that a collision is expected as shown in FIG. 8. In other words, FIG. 8 illustrates a scheme where the resource used for transmitting the inter-UE coordination message, e.g., PSFCH resource, is derived based on the slot/resources where the information used to determine an expected collision, e.g., UE-B's SCI, is transmitted. First available PSFCH resource is one other than the one that is immediately after the resource carrying SCI.

In regard to the behavior of the second UE 602-B, the second UE 602-B does not monitor the allocated resources for an inter-UE coordination message if the corresponding resource used by the first UE 602-A for transmitting the inter-UE coordination message (e.g., a PSFCH resource) does not fulfill the aforementioned rules. That is, the time of the resource is after n-T, where; n is the slot where the conflict is expected. In one example, T is equal to the IUC processing time. In another example, T is either a pre-defined value in the specification or (pre-) configured value. The rule for the second UE 602-B to monitor the allocated resources for an inter-UE coordination message specifies that the time (c) when the inter-UE coordination message is to be received must be before the time (b) when a collision between a first transmission by the second UE 602-B and a second transmission by another UE 602-C is expected to occur by at least the processing time (e) for processing the inter-UE coordination message at the second UE 602-B.

In case the inter-UE coordination message is transmitted not following the aforementioned rules, e.g., the UE 602-B cannot perform the action associated to the inter-UE coordination message reception before its transmission, the receiver UE, i.e., the second UE 602-B, discards the information in the inter-UE coordination message and keeps its previously defined resources for transmission.

### Example Rule 2: Solution for Option 2

In this part, example rules for determining whether to transmit the inter-UE coordination message for the case that the resource used for transmitting the inter-UE coordination message is determined from the resource on which the collision is expected (Option 2 described in the Introduction section above for Scheme 2).

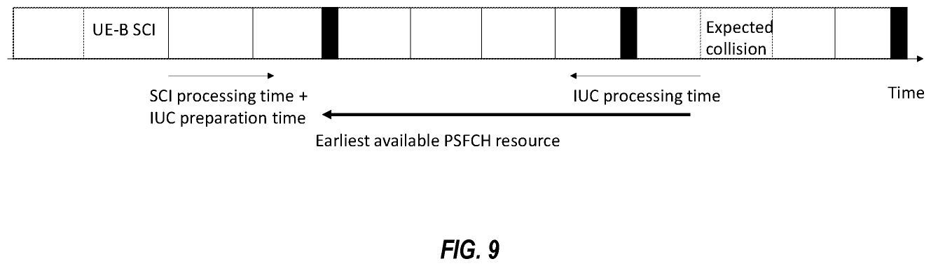

In regard to the behavior of the first UE 602-A, for this rule, the first UE 602-A transmits the inter-UE coordination message if the sum of the time in which the first UE 602-A receives the message (e.g., an SCI) from which it determines the collision condition plus the time to process the received message plus the time to prepare the inter-UE coordination message is less than the time of the resource in which the inter-UE coordination message is to be transmitted. This is illustrated in FIG. 9.

In relative timing, this can be expressed as: the first UE 602-A transmits the inter-UE coordination message if the sum of the time to process the received message plus the time to prepare the inter-UE coordination message is less than the time left until the resource in which the inter-UE coordination message is to be transmitted. The rule for the first UE 602-A to transmit the inter-UE coordination message specifies that the time (c) when the inter-UE coordination message is to be transmitted must be after the time (f) at which the message from the second UE 602-B was received by at least a sum of the processing time (g) for processing the received message at the first UE 602-A and the preparation time (d) for preparing the inter-UE coordination message at the first UE 602-A.

As described earlier and as illustrated in FIG. 9, due to the processing time, the inter-UE coordination message may have to be transmitted in a PSFCH resource other than the one that is immediately preceding the resource on which the collision is expected.

In regarding to the behavior of the second UE 602-B, the second UE 602-B does not monitor the allocated resources for an inter-UE coordination message if the corresponding resource used by the first UE 602-A for transmitting the inter-UE coordination message (e.g., a PSFCH resource) is before n+T, where n is the slot where the second UE's SCI is transmitted, and T is the value of SCI processing time plus inter-UE coordination message preparation time. If multiple different values are defined, then the one(s) resulting in the most stringent constraint may be used (e.g., minimum possible value). T can be either pre-defined in the specification or (pre-) configured. The rule for the second UE 602-B to monitor the allocated resources for an inter-UE coordination message specifies that the time (c) when the inter-UE coordination message is to be received must be after the time (f) at which the message from the second UE 602-B to the first UE 602-A was transmitted by at least a sum of the processing time (g) for processing the transmitted message at the first UE 602-A and the preparation time (d) for preparing the inter-UE coordination message at the first UE 602-A.

In case the inter-UE coordination message is transmitted not following the aforementioned rules, e.g., the second UE 602-B cannot perform the action associated to the inter-UE coordination message reception before its transmission, the receiver UE, i.e., the UE 602-B, discards the information in the inter-UE coordination message and keeps its previously defined resources for transmission.

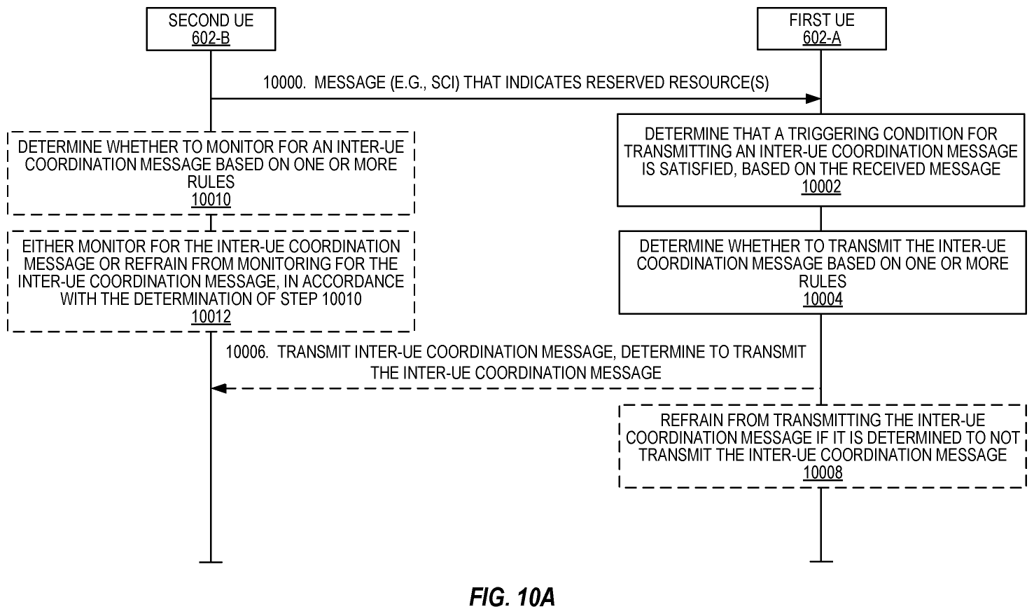

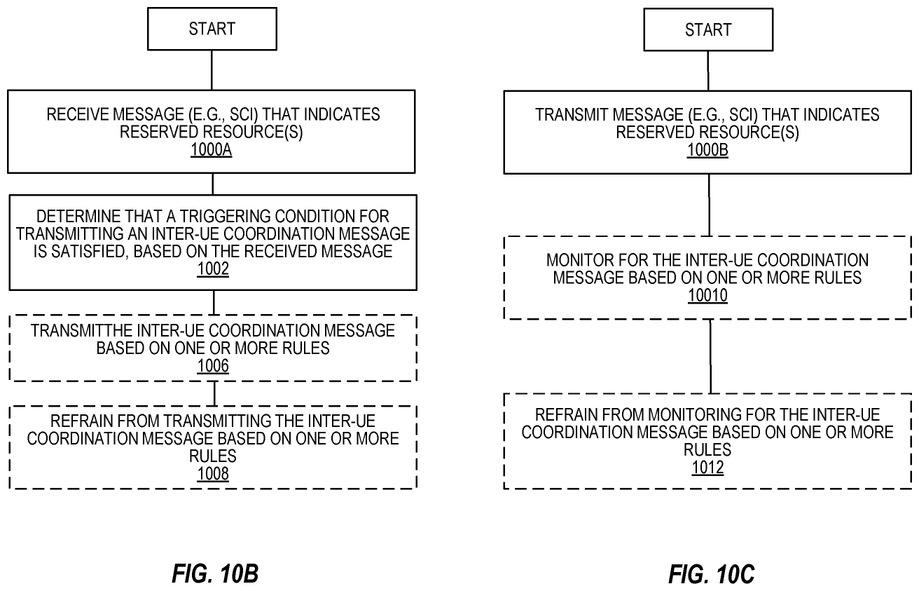

FIG. 10A illustrates the operation of the first UE 602-A and the second UE 602-B in accordance with one example embodiment of the present disclosure. As illustrated, the first UE 602-A receives a message (e.g., a SCI) from the second UE 602-B, where the received message indicates a resource(s) in the future reserved for transmission by the second UE 602-B (step 10000). Based on the received message, the first UE 602-A determines that a triggering condition (e.g., a potential collision is detected-a potential collision between a resource reservation of the second UE 602-B and a resource reservation of the third UE 602-C, or the unavailability of a receiver is determined) for transmitting an inter-UE coordination message is satisfied (step 10002). The first UE 602-A determines whether to transmit the inter-UE coordination message based on one or more rules, as described above (step 10004). If the first UE 602-A determines that the inter-UE coordination message is to be transmitted, the first UE 602-A transmits the inter-UE coordination message to the second UE 602-B (step 10006). Otherwise, if the first UE 602-A determines that the inter-UE coordination message is not to be transmitted (or not expected to be transmitted), the first UE 602-A refrains from transmitting the inter-UE coordination message (step 10008), as described above.

At the second UE 602-B, the second UE 602-B determines whether to monitor for the inter-UE coordination message based on one or more rules, as described above (step 10010). The second UE 602-B either monitors for the inter-UE coordination message or refrains from monitoring for the inter-UE coordination message, in accordance with the determination of step 1010 (step 10012).

In some examples, the time when the inter-UE coordination message is to be transmitted is based on a resource at which the message (e.g., SCI) was received. In some examples, the time when the inter-UE coordination message is to be transmitted is based on the one or more resources reserved for a future sidelink transmission by the second UE 602-B.

The inter-UE coordination message is to be transmitted based on the one or more rules described above being met. The inter-UE coordination message is not to be transmitted based on the one or more rules described above not being met.

In some examples, the triggering condition is satisfied upon detection of a conflict between the one or more resources reserved by the second UE 602-B for a future sidelink transmission and one or more resources reserved by a third UE 602-B for a future sidelink transmission or determining that a receiver of the first UE 602-B is unavailable to receive a sidelink transmission from the second UE 602-B on the one or more resources reserved by the second UE 602-B for a future sidelink transmission. In another examples, the triggering condition is satisfied upon determining that a receiver of the second UE 602-B is unavailable to receive one or more associated sidelink transmissions.

FIG. 10B illustrates the operation of the first UE 602-A in accordance with one example embodiment of the present disclosure. The method is performed by the first UE 602-A for autonomous resource allocation. The first UE 602-A receives (step 1000A) from a second UE 602-B a message (e.g., SCI) that indicates one or more resources reserved for a future sidelink transmission by the second UE 602-B. The first UE 602-A then processes the received message. Based on the received message, the first UE 602-A determines (step 1002) that a triggering condition for transmission of an inter-UE coordination message is satisfied. The first UE 602-A either transmits (step 1006) the inter-UE coordination message or refrains (step 1008) from transmitting the inter-UE coordination message, based on one or more rules for determining whether to transmit the inter-UE coordination message.

FIG. 10C illustrates the operation of the second UE 602-B in accordance with one example embodiment of the present disclosure. The method is performed by the second UE 602-B for autonomous resource allocation. The second UE 602-B transmits (step 1000B) to the first UE 602-A a message that indicates one or more resources reserved for a future sidelink transmission by the second UE 602-B. The second UE 602-B either monitors (step 1010) for an inter-UE coordination message or refrains (step 1012) from monitoring for the inter-UE coordination message, based on one or more rules for determining whether to monitor for the inter-UE coordination message.

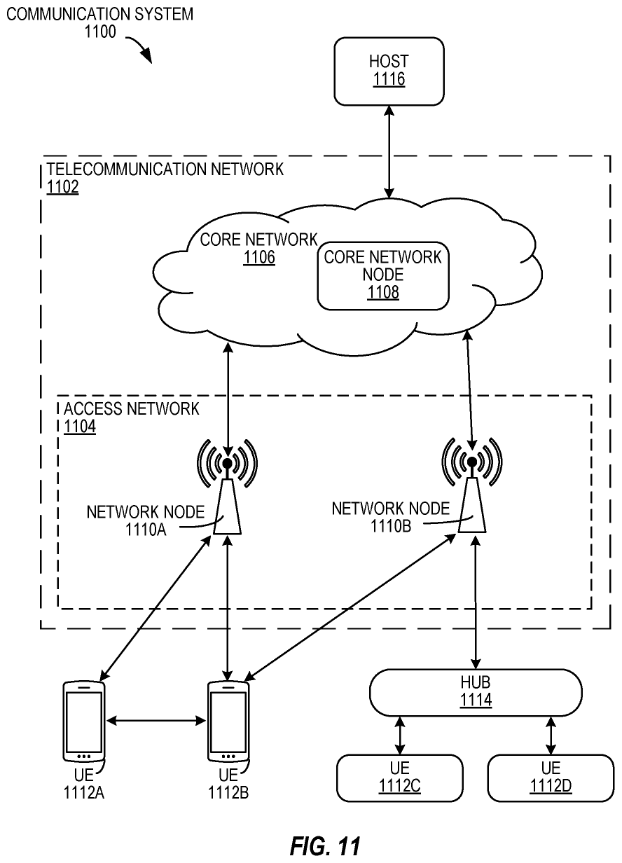

FIG. 11 shows an example of a communication system 1100 in accordance with some embodiments.

In the example, the communication system 1100 includes a telecommunication network 1102 that includes an access network 1104, such as a Radio Access Network (RAN), and a core network 1106, which includes one or more core network nodes 1108. The access network 1104 includes one or more access network nodes, such as network nodes 1110A and 1110B (one or more of which may be generally referred to as network nodes 1110), or any other similar Third Generation Partnership Project (3GPP) access node or non-3GPP Access Point (AP). The network nodes 1110 facilitate direct or indirect connection of User Equipment (UE), such as by connecting UEs 1112A, 1112B, 1112C, and 1112D (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system 1100 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1102 is a cellular network that implements 3GPP standardized features. Accordingly, the telecommunication network 1102 may support network slicing to provide different logical networks to different devices that are connected to the telecommunication network 1102. For example, the telecommunication network 1102 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1114 communicates with the access network 1104 to facilitate indirect communication between one or more UEs (e.g., UE 1112C and/or 1112D) and network nodes (e.g., network node 1110B). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a Virtual Reality (VR) headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110B. The hub 1114 may also allow for a different communication scheme and/or schedule between the hub 1114 and UEs (e.g., UE 1112C and/or 1112D), and between the hub 1114 and the core network 1106. In other examples, the hub 1114 is connected to the core network 1106 and/or one or more UEs via a wired connection. Moreover, the hub 1114 may be configured to connect to a Machine-to-Machine (M2M) service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110B. In other embodiments, the hub 1114 may be a non-dedicated hub—that is, a device which is capable of operating to route communications between the UEs and the network node 1110B, but which is additionally capable of operating as a communication start and/or end point for certain data channels.

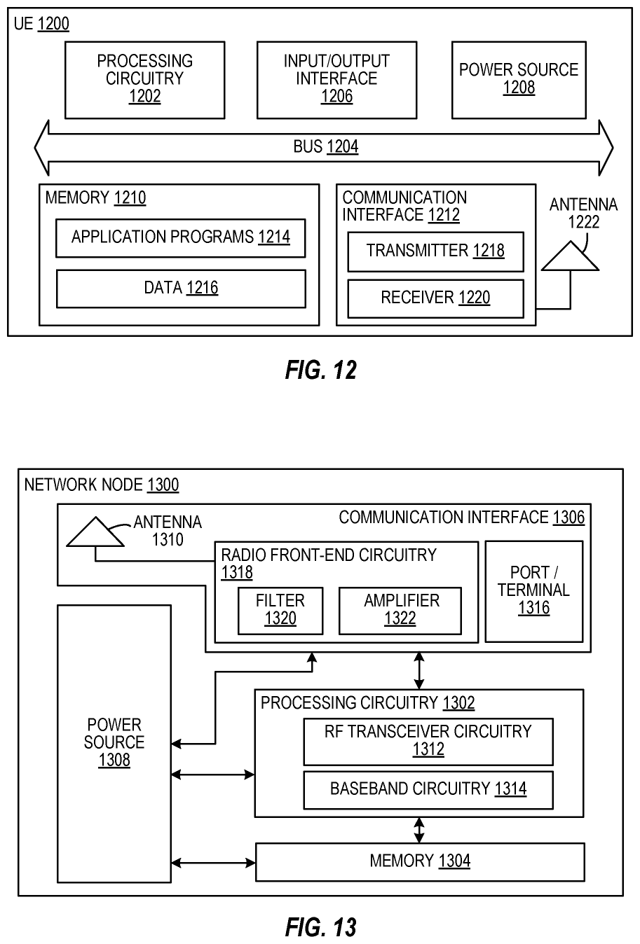

FIG. 12 shows a UE 1200 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1202 may include multiple Central Processing Units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging the power source 1208. Power circuitry may perform any formatting, converting, or other modification to the power from the power source 1208 to make the power suitable for the respective components of the UE 1200 to which power is supplied.

The memory 1210 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1210 may allow the UE 1200 to access instructions, application programs, and the like stored on transitory or non-transitory memory media, to off-load data, or to upload data. An article of manufacture, such as one utilizing a communication system, may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., the antenna 1222) and may share circuit components, software, or firmware, or alternatively be implemented separately.

In the illustrated embodiment, communication functions of the communication interface 1212 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet. Transmission Control Protocol/Internet Protocol (TCP/IP). Synchronous Optical Networking (SONET), Asynchronous Transfer Mode (ATM). Quick User Datagram Protocol Internet Connection (QUIC), Hypertext Transfer Protocol (HTTP), and so forth.

Regardless of the type of sensor, a UE may provide an output of data captured by its sensors, through its communication interface 1212, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 13 shows a network node 1300 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs). Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes. Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes processing circuitry 1302, memory 1304, a communication interface 1306, and a power source 1308. The network node 1300 may be composed of multiple physically separate components (e.g., a Node B component and an RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1300 may be configured to support multiple RATs. In such embodiments, some components may be duplicated (e.g., separate memory 1304 for different RATs) and some components may be reused (e.g., an antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1300.

The processing circuitry 1302 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1300 components, such as the memory 1304, to provide network node 1300 functionality.

In some embodiments, the processing circuitry 1302 includes a System on a Chip (SOC). In some embodiments, the processing circuitry 1302 includes one or more of Radio Frequency (RF) transceiver circuitry 1312 and baseband processing circuitry 1314. In some embodiments, the RF transceiver circuitry 1312 and the baseband processing circuitry 1314 may be on separate chips (or sets of chips), boards, or units, such as radio units and digital units. In alternative embodiments, part or all of the RF transceiver circuitry 1312 and the baseband processing circuitry 1314 may be on the same chip or set of chips, boards, or units.

The memory 1304 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and the memory 1304 are integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. The radio front-end circuitry 1318 comprises filters 1320 and amplifiers 1322. The radio front-end circuitry 1318 may be connected to the antenna 1310 and the processing circuitry 1302. The radio front-end circuitry 1318 may be configured to condition signals communicated between the antenna 1310 and the processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of the filters 1320 and/or the amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface 1306 may comprise different components and/or different combinations of components.

In certain alternative embodiments, the network node 1300 does not include separate radio front-end circuitry 1318; instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes the one or more ports or terminals 1316, the radio front-end circuitry 1318, and the RF transceiver circuitry 1312 as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, the communication interface 1306, and/or the processing circuitry 1302 may be configured to perform any receiving operations and/or certain obtaining operations described herein as being performed by the network node 1300. Any information, data, and/or signals may be received from a UE, another network node, and/or any other network equipment. Similarly, the antenna 1310, the communication interface 1306, and/or the processing circuitry 1302 may be configured to perform any transmitting operations described herein as being performed by the network node 1300. Any information, data, and/or signals may be transmitted to a UE, another network node, and/or any other network equipment.

The power source 1308 provides power to the various components of the network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid or an electricity outlet) via input circuitry or an interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

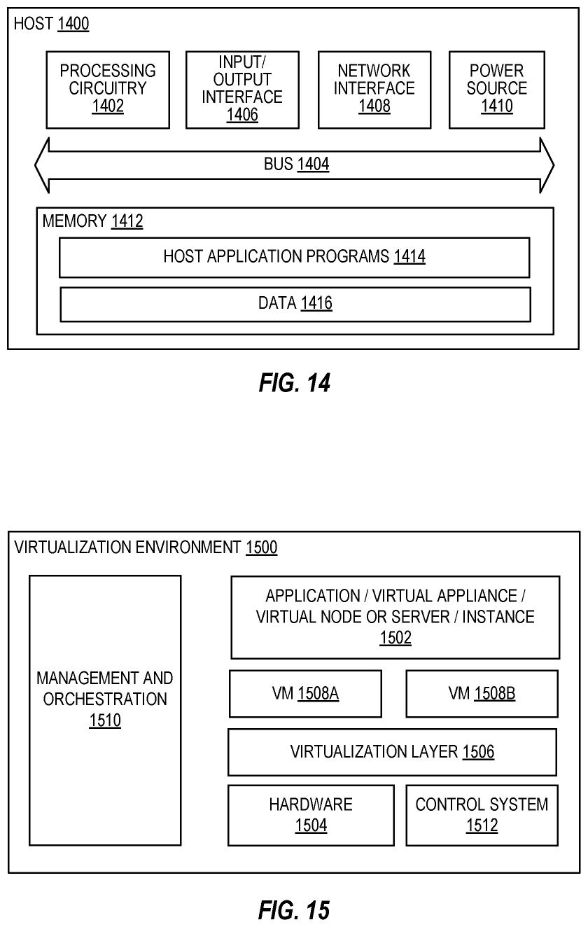

FIG. 14 is a block diagram of a host 1400, which may be an embodiment of the host 1116 of FIG. 11, in accordance with various aspects described herein. As used herein, the host 1400 may be or comprise various combinations of hardware and/or software including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and memory 1412. Other components may be included in other embodiments. Features of these components may be substantially similar to those described with respect to the devices of previous figures, such as FIGS. 12 and 13, such that the descriptions thereof are generally applicable to the corresponding components of the host 1400.

The memory 1412 may include one or more computer programs including one or more host application programs 1414 and data 1416, which may include user data, e.g. data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for Over-The-Top (OTT) services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or VM Monitors (VMMs)), provide VMs 1508A and 1508B (one or more of which may be generally referred to as VMs 1508), and/or perform any of the functions, features, and/or benefits described in relation with some embodiments described herein. The virtualization layer 1506 may present a virtual operating platform that appears like networking hardware to the VMs 1508.

The VMs 1508 comprise virtual processing, virtual memory, virtual networking, or interface and virtual storage, and may be run by a corresponding virtualization layer 1506. Different embodiments of the instance of a virtual appliance 1502 may be implemented on one or more of the VMs 1508, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1508 may be a software implementation of a physical machine that runs programs as if they were executing on a physical, non-virtualized machine. Each of the VMs 1508, and that part of the hardware 1504 that executes that VM, be it hardware dedicated to that VM and/or hardware shared by that VM with others of the VMs 1508, forms separate virtual network elements. Still in the context of NFV, a virtual network function is responsible for handling specific network functions that run in one or more VMs 1508 on top of the hardware 1504 and corresponds to the application 1502.

The hardware 1504 may be implemented in a standalone network node with generic or specific components. The hardware 1504 may implement some functions via virtualization. Alternatively, the hardware 1504 may be part of a larger cluster of hardware (e.g., such as in a data center or CPE) where many hardware nodes work together and are managed via management and orchestration 1510, which, among others, oversees lifecycle management of the applications 1502. In some embodiments, the hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1512 which may alternatively be used for communication between hardware nodes and radio units.

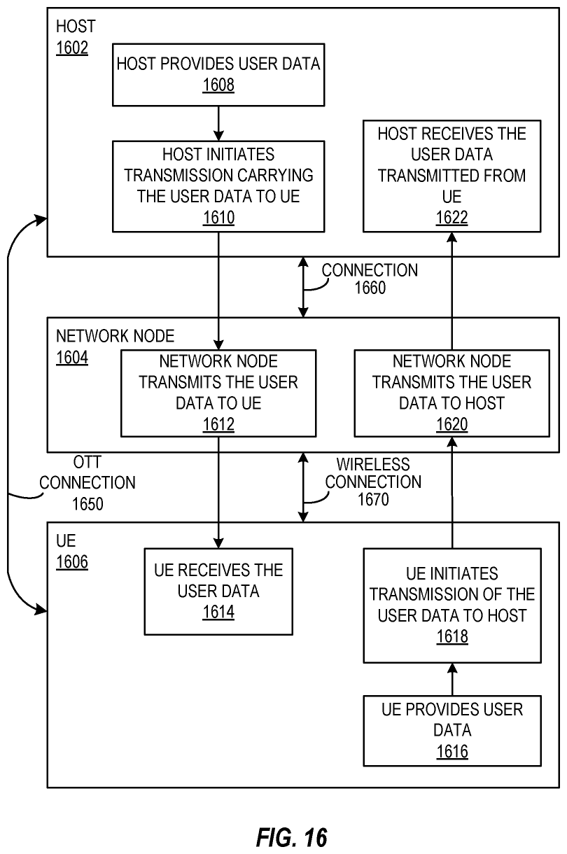

FIG. 16 shows a communication diagram of a host 1602 communicating via a network node 1604 with a UE 1606 over a partially wireless connection in accordance with some embodiments. Example implementations, in accordance with various embodiments, of the UE (such as the UE 1112A of FIG. 11 and/or the UE 1200 of FIG. 12), the network node (such as the network node 1110A of FIG. 11 and/or the network node 1300 of FIG. 13), and the host (such as the host 1116 of FIG. 11 and/or the host 1400 of FIG. 14) discussed in the preceding paragraphs will now be described with reference to FIG. 16.

Like the host 1400, embodiments of the host 1602 include hardware, such as a communication interface, processing circuitry, and memory. The host 1602 also includes software, which is stored in or is accessible by the host 1602 and executable by the processing circuitry. The software includes a host application that may be operable to provide a service to a remote user, such as the UE 1606 connecting via an OTT connection 1650 extending between the UE 1606 and the host 1602. In providing the service to the remote user, a host application may provide user data which is transmitted using the OTT connection 1650.

The network node 1604 includes hardware enabling it to communicate with the host 1602 and the UE 1606 via a connection 1660. The connection 1660 may be direct or pass through a core network (like the core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by the UE 1606 and executable by the UE's processing circuitry. The software includes a client application, such as a web browser or operator-specific “app” that may be operable to provide a service to a human or non-human user via the UE 1606 with the support of the host 1602. In the host 1602, an executing host application may communicate with the executing client application via the OTT connection 1650 terminating at the UE 1606 and the host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via the connection 1660 between the host 1602 and the network node 1604 and via a wireless connection 1670 between the network node 1604 and the UE 1606 to provide the connection between the host 1602 and the UE 1606. The connection 1660 and the wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604 in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR, or AR which it can broadcast, multicast, or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1650 between the host 1602 and the UE 1606 in response to variations in the measurement results. The measurement procedure and/or the network functionality for reconfiguring the OTT connection 1650 may be implemented in software and hardware of the host 1602 and/or the UE 1606. In some embodiments, sensors (not shown) may be deployed in or in association with other devices through which the OTT connection 1650 passes; the sensors may participate in the measurement procedure by supplying values of the monitored quantities exemplified above, or by supplying values of other physical quantities from which software may compute or estimate the monitored quantities. The reconfiguring of the OTT connection 1650 may include message format, retransmission settings, preferred routing, etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency, and the like by the host 1602. The measurements may be implemented in that software causes messages to be transmitted, in particular empty or dummy messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

### EXAMPLES

### Group A Examples

1. A method performed by a first User Equipment, UE, (602-A) for inter-UE coordination for autonomous sidelink resource allocation, the method comprising:
   receiving (1000), from a second UE (602-B), a message that indicates one or more resources reserved for future sidelink transmission(s) by the second UE (602-B);
   determining (1002) that a triggering condition for transmission of an inter-UE coordination message is satisfied, based on the received message;
   determining (1004) whether to transmit the inter-UE coordination message based on one or more rules; and
   either transmitting (1006) the inter-UE coordination message or refraining (1008) from transmitting the inter-UE coordination message, in accordance with the determining (1004) whether to transmit the inter-UE coordination message based on the one or more rules.
2. The method of example 1 wherein the one or more rules are based on:
   (a) a time at which the triggering condition for transmission of the inter-UE coordination message was detected;
   (b) a time when a collision between a first transmission(s) by the second UE (602-B) and second transmission(s) by another UE (602-C) is (are) to occur;
   (c) a time when the inter-UE coordination message is to be transmitted or can be transmitted;
   (d) a preparation time for the inter-UE coordination message at the first UE (602-A); (e) a processing time for inter-UE coordination message at the second UE (602-B);
   (f) a time at which the message received from the second UE (602-B) was received;
   (g) a combination of any two or more of (a)-(f).
3. The method of example 2 wherein the time when the inter-UE coordination message is to be transmitted or can be transmitted is based on a time at which the received message was received.
4. The method of example 2 wherein the time when the inter-UE coordination message is to be transmitted or can be transmitted is based on the one or more resources reserved for future sidelink transmission(s) by the second UE (602-B).
5. The method of example 2 wherein the time when the inter-UE coordination message is to be transmitted or can be transmitted is based on a time at which the one or more resources reserved for future sidelink transmission(s) by the second UE (602-B) occur.
6. The method of example 2 wherein the one or more rules comprise a rule that is based on time (b) minus time (e) or a lower bound of time (b) minus time (e) (e.g., a bound Y such that Y<time (b)−time (e)).
7. The method of example 2 wherein the one or more rules comprise a rule that is based on a comparison of a first time and a second time, wherein the first time is based on or equal to time (b) minus time (e) or a lower bound of time (b) minus time (e) and the second time is based on or equal to time (c).
8. The method of example 2 wherein the one or more rules comprise a rule that is based on a sum of time (g) and time (d) or a higher bound of the sum of time (g) and time (d) (e.g., a bound X such that X>time (g) plus time (d)).
9. The method of example 2 wherein the one or more rules comprise a rule that is based on a sum of time (a) and time (d) or a higher bound of the sum of time (a) and time (d) (e.g., a bound X such that X>time (a) plus time (d)).
10. The method of example 2 wherein the one or more rules comprise a rule that is based on a comparison of a first time and a second time, wherein the first time is based on or equal to a sum of time (g) and time (d) or a higher bound of the sum of time (g) and time (d) and the second time is based on or equal to time (c).
11. The method of example 2 wherein the one or more rules comprise a rule that is based on a comparison of a first time and a second time, wherein the first time is based on or equal to a sum of time (a) and time (d) or a higher bound of the sum of time (a) and time (d) and the second time is based on or equal to time (c).
12. The method of any of examples 1 to 11 wherein determining (1004) whether to transmit the inter-UE coordination message based on the one or more rules comprises determining (1004) whether the inter-UE coordination message is to be transmitted based on the one or more rules.
13. The method of any of examples 1 to 11 wherein determining (1004) whether to transmit the inter-UE coordination message based on the one or more rules comprises determining (1004) whether the inter-UE coordination message is not to be transmitted based on the one or more rules.
14. The method of any of examples 1 to 13 wherein the steps of receiving (1000) the message, determining (1002) that the triggering condition is satisfied, determining (1004) whether to transmit the inter-UE coordination message, and either transmitting (1006) the inter-UE coordination message or refraining (1008) from transmitting the inter-UE coordination message are performed in association with (e.g., as part of) autonomous resource allocation for sidelink transmissions between UEs including the first UE (602-A) and the second UE (602-B).
15. The method of example 14 wherein the autonomous resource allocation is Mode 2 resource allocation for New Radio, NR, sidelink transmissions.
16. The method of any of examples 1 to 15 wherein the triggering condition is detection of a conflict between the one or more resources reserved by the second UE (602-B) for future sidelink transmission(s) and one or more resources reserved by a third UE (602-B) for future sidelink transmissions or determining that a receiver of the first UE (602-B) is unavailable to receive an a sidelink transmission from the second UE (602-B) on the one or more resources reserved by the second UE (602-B) for future sidelink transmissions.
17. The method of any of examples 1 to 15 wherein the triggering condition is determining that a receiver of the second UE (602-B) is unavailable to receive one or more associated sidelink transmissions.
18. The method of any of examples 1 to 17, further comprising:
   providing user data (e.g., from a sidelink transmission from the second UE (602-B)); and
   forwarding the user data to a host via a transmission to a network node.
19. A method performed by a second User Equipment, UE, (602-B) for inter-UE coordination for autonomous sidelink resource allocation, the method comprising:
   transmitting (1000), to a first UE (602-A), a message that indicates one or more resources reserved for future sidelink transmission(s) by the second UE (602-B);
   determining (1010) whether to monitor for an inter-UE coordination message from the first UE (602-B) based on one or more rules, the inter-UE coordination message being one related to the one or more resources reserved for future sidelink transmission(s) by the second UE (602-B); and
   either monitoring (1012) for the inter-UE coordination message or refraining (1012) from monitoring for the inter-UE coordination message, in accordance with the determining (1010) whether to monitor for an inter-UE coordination message from the first UE (602-B) based on one or more rules.
20. The method of example 19 wherein the one or more rules are based on:
   (a) a time at which the triggering condition for transmission of the inter-UE coordination message was detected;
   (b) a time when a collision between a first transmission(s) by the second UE (602-B) and second transmission(s) by another UE (602-C) is (are) to occur;
   (c) a time when the inter-UE coordination message is to be received or can be received;
   (d) a preparation time for the inter-UE coordination message at the first UE (602-A);
   (e) a processing time for inter-UE coordination message at the second UE (602-B);
   (f) a time at which the message transmitted to the first UE (602-A) was transmitted;
   (g) a combination of any two or more of (a)-(e).
21. The method of example 20 wherein the time when the inter-UE coordination message is to be transmitted or can be transmitted is based on a time at which the transmitted message was transmitted.
22. The method of example 20 wherein the time when the inter-UE coordination message is to be transmitted or can be transmitted is based on the one or more resources reserved for future sidelink transmission(s) by the second UE (602-B).
23. The method of example 20 wherein the time when the inter-UE coordination message is to be transmitted or can be transmitted is based on a time at which the one or more resources reserved for future sidelink transmission(s) by the second UE (602-B) occur.
24. The method of example 20 wherein the one or more rules comprise a rule that is based on time (b) minus time (e) or a lower bound of time (b) minus time (e) (e.g., a bound Y such that Y<time (b)−time (e)).
25. The method of example 20 wherein the one or more rules comprise a rule that is based on a comparison of a first time and a second time, wherein the first time is based on or equal to time (b) minus time (e) or a lower bound of time (b) minus time (e) and the second time is based on or equal to time (c).
26. The method of example 20 wherein the one or more rules comprise a rule that is based on a sum of time (g) and time (d) or a higher bound of the sum of time (g) and time (d) (e.g., a bound X such that X>time (g) plus time (d)).
27. The method of example 20 wherein the one or more rules comprise a rule that is based on a sum of time (a) and time (d) or a higher bound of the sum of time (a) and time (d) (e.g., a bound X such that X>time (a) plus time (d)).
28. The method of example 20 wherein the one or more rules comprise a rule that is based on a comparison of a first time and a second time, wherein the first time is based on or equal to a sum of time (g) and time (d) or a higher bound of the sum of time (g) and time (d) and the second time is based on or equal to time (c).
29. The method of example 20 wherein the one or more rules comprise a rule that is based on a comparison of a first time and a second time, wherein the first time is based on or equal to a sum of time (a) and time (d) or a higher bound of the sum of time (a) and time (d) and the second time is based on or equal to time (c).
30. The method of any of examples 19 to 29 wherein determining (1004) whether to transmit the inter-UE coordination message based on the one or more rules comprises determining (1004) whether the inter-UE coordination message is to be transmitted based on the one or more rules.
31. The method of any of examples 19 to 29 wherein determining (1004) whether to transmit the inter-UE coordination message based on the one or more rules comprises determining (1004) whether the inter-UE coordination message is not to be transmitted based on the one or more rules.
32. The method of any of examples 19 to 31 wherein the steps of transmitting (1000) the message, determining (1010) whether to monitor for the inter-UE coordination message, and either monitoring (1012) for the inter-UE coordination message or refraining (1012) from monitoring for the inter-UE coordination message are performed in association with (e.g., as part of) autonomous resource allocation for sidelink transmissions between UEs including the first UE (602-A) and the second UE (602-B).
33. The method of example 32 wherein the autonomous resource allocation is Mode 2 resource allocation for New Radio, NR, sidelink transmissions.
34. The method of any of examples 19 to 33, further comprising:
   providing user data; and
   forwarding the user data to a host via a transmission to a network node via a sidelink transmission to another UE (e.g., the first UE 602-A).

### Group B Examples

35. A user equipment comprising:
   processing circuitry configured to perform any of the steps of any of the Group A examples; and
   power supply circuitry configured to supply power to the processing circuitry.
36. A user equipment (UE) comprising:
   an antenna configured to send and receive wireless signals;
   radio front-end circuitry connected to the antenna and to processing circuitry, and configured to condition signals communicated between the antenna and the processing circuitry; the processing circuitry being configured to perform any of the steps of any of the Group A examples;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
37. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A examples to receive the user data from the host.
38. The host of the previous example, wherein the cellular network further includes a network node configured to communicate with the UE to transmit the user data to the UE from the host.
39. The host of the previous 2 examples, wherein:
   the processing circuitry of the host is configured to execute a host application, thereby providing the user data; and
   the host application is configured to interact with a client application executing on the UE, the client application being associated with the host application.
40. A method implemented by a host operating in a communication system that further includes a network node and a user equipment (UE), the method comprising:
   providing user data for the UE; and initiating a transmission carrying the user data to the UE via a cellular network comprising
   the network node, wherein the UE performs any of the operations of any of the Group A examples to receive the user data from the host.
41. The method of the previous example, further comprising:
   at the host, executing a host application associated with a client application executing on the UE to receive the user data from the UE.
42. The method of the previous example, further comprising:
   at the host, transmitting input data to the client application executing on the UE, the input data being provided by executing the host application,
   wherein the user data is provided by the client application in response to the input data from the host application.
43. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A examples to transmit the user data to the host.
44. The host of the previous example, wherein the cellular network further includes a network node configured to communicate with the UE to transmit the user data from the UE to the host.
45. The host of the previous 2 examples, wherein:
   the processing circuitry of the host is configured to execute a host application, thereby providing the user data; and
   the host application is configured to interact with a client application executing on the UE, the client application being associated with the host application.
46. A method implemented by a host configured to operate in a communication system that further includes a network node and a user equipment (UE), the method comprising:
   at the host, receiving user data transmitted to the host via the network node by the UE, wherein the UE performs any of the steps of any of the Group A examples to transmit the user data to the host.
47. The method of the previous example, further comprising:
   at the host, executing a host application associated with a client application executing on the UE to receive the user data from the UE.
48. The method of the previous example, further comprising:
   at the host, transmitting input data to the client application executing on the UE, the input data being provided by executing the host application,
   wherein the user data is provided by the client application in response to the input data from the host application.

Additional details on mode 2 enhancements for inter-UE coordination are described as following.

### Scheme 2

### UE Procedure for IUC Indication

In RAN1 #106bis-e, the following agreement was made on how to convey the presence of expected/potential resource conflict on reserved resource(s) indicated by UE-B's SCI.

Agreement
For Scheme 2, PSFCH format 0 is used to convey the presence of expected/potential resource
conflict on reserved resource(s) indicated by UE-B's SCI.

Regarding the physical layer procedure to determine the PSFCH resource for the transmission of inter-UE coordination in scheme 2, we propose to reuse as much as possible the PSFCH procedure for HARQ feedback which was specified for NR SL Rel-16. Based on this, the following was agreed in the last RAN1 #106bis-e meeting. FFS is the abbreviation of “for further study”.

Agreement
For allocating PSFCH resources in Scheme 2, at least following can be (pre)configured
separately from those for SL HARQ-ACK feedback.

| | |
|---|---|
| • | Set of PRBs for PSFCH transmission/reception (sl-PSFCH-RB-Set) |

Agreement
For Scheme 2,

| • | Index of a PSFCH resource for inter-UE coordination information transmission is |
|---|---|
| | determined in the same way according to Rel-16 TS 38.213 Section 16.3 with at least |
| | following modification |
| | - P_ID is L1-Source ID indicated by UE-B's SCI |
| | - M_ID is 0 |
| • | FFS: How to set m_CS |
| • | FFS: How to set m_0 |
| • | FFS: Whether M_ID can be (pre)configured |

When it comes to m_CS, we believe that the IUC indication from all UE—As for a particular resource conflict should use the same resource (time, frequency and sequence) and given that the UE-B behaviour on receiving the IUC indication should be the same (i.e. performing resource (re-) selection, there is no advantage in differentiating the indication for different kind of collisions (e.g. collision with reservations from other UEs or when UE-A does not expect to perform reception). Therefore, we propose to set m_CS to zero in all the cases.

Proposal 1 m_CS is Set to 0 for Both the Condition 2-A-1 and Condition 2-A-2, Agreed in the Previous RAN1 Meeting.

For determining m_0), we propose to reuse Rel. 16 procedure i.e., a UE determines m_0) value from a cyclic shift pair index corresponding to a PSFCH resource index and from N_{CS}^{PSFCH} using Table 16.3-1 in TS 38.312.

### Proposal 2 m_0 Value is Determined According to Rel. 16 Procedure (i.e., Using Table 16.3-1 in TS38.313).

For determining PSFCH occasion in Scheme 2, the following two options have been discussed.
Option 1: PSFCH occasion is derived by a slot where UE-B's SCI is transmitted.
Option 2: PSFCH occasion is derived by a slot where expected/potential resource conflict occurs on PSSCH resource indicated by UE-B's SCI.

Among the two options, we have a preference for option 1 because it will allow the transmission of IUC indication as soon as the resource conflict is detected (thus allowing UE-B with more time to perform resource reselection in the remaining PDB) by reusing the Rel. 16 PSFCH resource occasion's determination procedure.

### Proposal 3 Option 1 is Supported for the Derivation of PSFCH Occasion.

However, irrespective of which option is selected to derive the PSFCH occasion, it is important that the processing times are taken into account. For example, in option 1, first available PSFCH resource for IUC indication is derived by a slot where UE-B's SCI is transmitted and considering the SCI processing time. IUC preparation time and IUC processing time. This is shown in FIG. 7 (Option 1 where the resource used for transmitting the IUC, e.g., PSFCH resource, is derived based on the slot/resources where the information used to determine an expected collision, e.g., UE-B's SCI, is transmitted).

Whereas, if option 2 is supported, the earliest available PSFCH resource for IUC indication is derived by a slot where expected/potential resource conflict occurs also considering the SCI processing time. IUC preparation time and IUC processing time as shown in FIG. 9 (Option 2 where the resource used for transmitting the IUC, e.g., PSFCH resource, is derived based on the slot/resources where the collision is expected).

In case the available PSFCH occasions does not fulfil the processing time limitations, the UE-A does not transmit any IUC indication i.e., UE-A drops the IUC transmission and UE-B is not expected to receive IUC indication (i.e., no monitoring of IUC is expected from UE-B on PSFCH occasions which do not fulfil processing time constraints).

### Proposal 4 No IUC Indication is Transmitted if the Available PSFCH Occasions do not Fulfil SCI/IUC Processing Time and IUC Preparation Time Constraints.

### Determination of UE-A and UE-B

When it comes to the question on which UE can be UE-A and UE-B, the following is agreed in RAN1 #106-e:

Agreement
In scheme 2, at least the following is supported for UE(s) to be UE-A(s)/UE-B(s) in the inter-
UE coordination transmission triggered by a detection of expected/potential resource conflict(s)
in Mode 2:

| • | A UE that transmitted PSCCH/PSSCH with SCI indicating reserved resource(s) to be | |
|---|---|---|
| | used for its transmission, received inter-UE coordination information from UE-A | |
| | indicating expected/potential resource conflict(s) for the reserved resource(s), and uses | |
| | it to determine resource re-selection is UE-B | |
| • | A UE that detects expected/potential resource conflict(s) on resource(s) indicated by UE- | |
| | B's SCI sends inter-UE coordination information to UE-B, subject to satisfy one of the | |
| | following conditions, is UE-A | |
| | ∘ | Working assumption At least a destination UE of one of the conflicting TBs, i.e., |

| TBs to be transmitted in the expected/potential conflicting resource(s) | |
|---|---|
| • | Whether a non-destination UE of a TB transmitted by UE-B can be UE- |

A is (pre-)configured

| | ∘ | FFS: Additional details and condition(s) on UE-A and UE-B |
|---|---|---|
| • | The above feature can be enabled or disabled or controlled by (pre-)configuration | |
| | ∘ | FFS: Details on how to support this, including (pre-)configuration signaling |
| | | granularity |

| | |
|---|---|
| • | FFS: Definition of expected/potential resource conflict(s) and other details (if any) |

Scheme 2 is suitable for coordination not only in unicast but also in groupcast or even broadcast. Thus, determining whether a UE acts as UE-A and/or UE-B cannot rely on having a connection between UEs (e.g., over PC5-RRC). The coordination information in Scheme 2 will provide information on expected/potential conflicts and/or detected resource conflicts. In our view, these conditions should trigger the transmission of inter-UE coordination information. That is, any UE that is capable of should transmit a coordination message after detecting the corresponding condition. Similarly, any UE receiving an inter-UE coordination message should react to it accordingly.

### Proposal 5 in Scheme 2:

Any UE that detects the corresponding triggering condition (i.e., an expected/potential conflict) transmits the coordination message and is a UE-A.
UE-B triggers a corresponding action (e.g., reselection of resources) upon receiving a coordination message.

### UE-B Behavior on the Reception of IUC Indication

In RAN1 #106-e, the following agreement was made for the action taken by the UE-B on the reception of IUC indication in Scheme 2.

Agreement
In scheme 2, the following UE-B's behavior in its resource (re)selection is supported when it
receives inter-UE coordination information from UE-A:

| • | UE-B can determine resource(s) to be re-selected based on the received coordination | |
|---|---|---|
| | information | |
| | ∘ | UE-B can reselect resource(s) reserved for its transmission when |

expected/potential resource conflict on the resource(s) is indicated
• FFS: Other details (if any)

According to the above agreement, UE-B triggers reselection of the resources upon receiving an inter-UE coordination message for Scheme 2. However, it could be the case that upon receiving the coordination message, UE-B cannot reliably re-select resources to perform its transmission, e.g., if the arrival of the coordination message is too close to the PDB not allowing for a minimum resource selection window. Therefore, we propose that upon receiving the resource coordination message—in the case where UE-B cannot re-select resources after receiving the IUC in scheme 2—it does not trigger reselection.

Proposal 6 UE-B does not Perform (Re)-Selection of Resources if it Cannot Find Enough Resources for its Transmission Due to Time of Arrival of the IUC.

### UE-A Behavior for Resource Conflict Determination and IUC Transmission

In RAN1 #106-e and RAN1 #106bis-e, the following was agreed on how UE-A determines the resource conflict.

Agreement
In scheme 2, at least the following is supported to determine inter-UE coordination information:

| - | Among resource(s) indicated by UE-B's SCI, UE-A considers that expected/potential | |
|---|---|---|
| | resource conflict occurs on the resource(s) satisfying at least one of the following | |
| | condition(s): | |
| | • | Condition 2-A-1: |

| ∘ | Other UE's reserved resource(s) identified by UE-A are fully/partially |
|---|---|
| | overlapping with resource(s) indicated by UE-B's SCI in time-and-frequency |
| ∘ | FFS: Other details (if any) |
| ∘ | FFS: Whether/how to specify additional criteria and other details (if any) |

including signaling details of conflict indication

| | |
|---|---|
| • | (Working Assumption) Condition 2-A-2: |

| | |
|---|---|
| ∘ | Resource(s) (e.g., slot(s)) where UE-A, when it is intended receiver of UE-B, |

does not expect to perform SL reception from UE-B due to half duplex
operation
✓ FFS: Other details (if any)

| | |
|---|---|
| - | FFS: Other condition(s) |

| | |
|---|---|
| - | FFS: Other details (if any) |

Agreement
For Condition 2-A-1 of Scheme 2, down-select one or more of following additional criteria to
determine resource(s) where expected/potential resource conflict occurs

| • | Option 1: The resource(s) are fully/partially overlapping in time-and-frequency with | |
|---|---|---|
| | other UE's reserved resource(s) whose RSRP measurement is larger than a RSRP | |
| | threshold according to the priorities included in the SCI: | |
| | - | prio_TX and prio_RX are the priorities indicated in the SCI making the overlapping |
| | | reservations |
| | - | Strive to reuse Rel-16 specification wherever possible |
| • | Option 2: The resource(s) are fully/partially overlapping in time-and-frequency with | |
| | other UE's reserved resource(s) whose RSRP measurement is within a (pre)configured | |
| | RSRP threshold compared to the RSRP measurement of UE-B's reserved resource. | |
| | - | FFS: Whether the threshold depends on priority |
| • | Option 3: The resource(s) are fully/partially overlapping in time-and-frequency with | |
| | other UE's reserved resource(s) and the other UE is within a distance threshold of UE- | |
| | B as determined by both UEs' SCIs. | |
| • | Option 4: The resource(s) are fully/partially overlapping in time-and-frequency with | |
| | other UE's reserved resource(s) whose RSRP measurement is larger a (pre)configured | |
| | RSRP threshold compared to the RSRP measurement of UE-B's reserved resource. | |
| | - | FFS: Whether the threshold depends on priority |

| | |
|---|---|
| • | FFS: In case of collisions of resources for two UEs having TBs with UE A as destination |
| | UE, if needed |

Out of the above options, we support Option 1. The remaining question is how to determine prio_TX and prio_RX for the determination of resource conflict. In other words, which SCI indicates prio_TX and prio_RX in order to reuse the Rel. 16 procedure. In our view, this is a configuration issue as RSRP threshold is defined according to prio_TX and prio_RX. If prio_TX—prio_RX and prio_RX—prio_TX are both configured to have a same RSRP threshold, it will not matter which SCI is associated to prio_TX and prio_RX. However, we propose to associate prio_TX to the SCI which allows the UE-A to determine the expected resource conflict.

### Proposal 7 UE Expects Symmetric Configuration of RSRP Thresholds Based on Priorities.

Proposal 8 Prio_TX is Determined from the Priority Indicated in SCI which Allows the UE-A to Determine the Expected Resource Conflict i.e., SCI which Comes at Later Time. Prio_RX is Determined from the Priority Indicated in SCI which Comes First i.e., UE-A Cannot Determine Resource Conflict Based on the SCI. In Case SCIs are Transmitted Simultaneously, it is Up to UE Implementation to Determine Prio_TX and Prio_RX.

Once UE-A determines the prio_TX and prio_RX, it can reuse the Rel. 16 procedure to determine the resource conflict.

### Proposal 9 Rel. 16 Procedure is Reused for Resource Conflict Determination by UE-A.

Furthermore, there could be scenarios when UE-A needs to transmit receive HARQ feedback and IUC indication in the same slot. For these scenarios, we propose to reuse Rel. 16 prioritization rules. In case, the total number of HARQ feedbacks and IUC indications happen to be more than N PSFCH (which is the number of simultaneous PSFCH transmissions that UE supports). HARQ feedbacks are considered to be of high priority as compared to IUC indication. The prioritization among IUC transmissions can be based on prio_TX.

### Proposal 10 HARQ Feedback has a Priority Over IUC and Rel. 16 Prioritization Rules for Simultaneous PSFCH Transmissions are Reused.

### Scenarios and Applicability

Use of PSFCH for conveying inter-UE coordination allows for using inter-UE coordination even when the number of potential UE—As is large. This is the case for groupcast communications (esp. Option 1) as well as broadcast communications. Furthermore, the applicability of Scheme 2 to unicast communications is straightforward. Based on this we propose the following.

### Proposal 11 Scheme 2 is Supported for Unicast, Groupcast (Options 1 and 2), and Broadcast SL Mode 2 Communications.

1. An inter-UE coordination method performed by a first User Equipment, UE, for autonomous resource allocation for sidelink transmission, the method comprising:
receiving, from a second UE, a message that indicates one or more resources reserved for a future sidelink transmission by the second UE;
determining that a triggering condition for transmission of an inter-UE coordination message is satisfied, based on the received message; and
either transmitting the inter-UE coordination message or refraining from transmitting the inter-UE coordination message, based on one or more rules for determining whether to transmit the inter-UE coordination message.

2. The method of claim 1 wherein the one or more rules are based on at least one of:
(a) a time at which the triggering condition for transmission of the inter-UE coordination message was detected;
(b) a time when a collision between a first transmission by the second UE and a second transmission by another UE is expected to occur;
(c) a time when the inter-UE coordination message is to be transmitted;
(d) a preparation time for the inter-UE coordination message at the first UE;
(e) a processing time for processing the inter-UE coordination message at the second UE;
(f) a time at which the message from the second UE was received;
(g) a processing time for processing the received message at the first UE.

3. The method of claim 1 wherein the time when the inter-UE coordination message is to be transmitted is based on a resource at which the message from the second UE was received.

4. The method of claim 1 wherein the time when the inter-UE coordination message is to be transmitted is based on the one or more resources reserved for a future sidelink transmission by the second UE.

5. The method of claim 2 wherein the one or more rules comprise a rule that specifies that the time (c) when the inter-UE coordination message is to be transmitted must be before the time (b) when a collision between a first transmission by the second UE and a second transmission by another UE is expected to occur by at least the processing time (e) for processing the inter-UE coordination message at the second UE.

6. The method of claim 2 wherein the one or more rules comprise a rule that specifies that the time (c) when the inter-UE coordination message is to be transmitted must be after the time (f) at which the message from the second UE was received by at least a sum of the processing time (g) for processing the received message at the first UE and the preparation time (d) for the inter-UE coordination message at the first UE.

7. The method of claim 1 wherein the inter-UE coordination message is to be transmitted based on the one or more rules being met.

8. The method of claim 1 wherein the inter-UE coordination message is not to be transmitted based on the one or more rules not being met.

9. The method of claim 1 wherein the autonomous resource allocation is Mode 2 resource allocation for New Radio, NR, sidelink transmissions.

10. The method of claim 1 wherein the triggering condition is satisfied upon detection of a conflict between the one or more resources reserved by the second UE for a future sidelink transmission and one or more resources reserved by a third UE for a future sidelink transmission or determining that a receiver of the first UE is unavailable to receive a sidelink transmission from the second UE on the one or more resources reserved by the second UE for a future sidelink transmission.

11. The method of claim 1 wherein the triggering condition is satisfied upon determining that a receiver of the second UE is unavailable to receive one or more associated sidelink transmissions.

12. An inter-UE coordination method performed by a second User Equipment, UE, for autonomous resource allocation for sidelink transmission, the method comprising:
transmitting, to a first UE, a message that indicates one or more resources reserved for a future sidelink transmission by the second UE; and
either monitoring for an inter-UE coordination message or refraining from monitoring for the inter-UE coordination message, based on one or more rules for determining whether to monitor for the inter-UE coordination message.

13. The method of claim 12 wherein the one or more rules are based on at least one of:
(a) a time at which the triggering condition for transmission of the inter-UE coordination message was detected;
(b) a time when a collision between a first transmission by the second UE and a second transmission by another UE is expected to occur;
(c) a time when the inter-UE coordination message is to be received;
(d) a preparation time for the inter-UE coordination message at the first UE;
(e) a processing time for processing the inter-UE coordination message at the second UE;
(f) a time at which the message to the first UE was transmitted;
(g) a processing time for processing the transmitted message at the first UE.

14. The method of claim 12 wherein the time when the inter-UE coordination message is to be transmitted is based on a resource at which the message from the second UE was transmitted.

15. The method of claim 12 wherein the time when the inter-UE coordination message is to be transmitted is based on the one or more resources reserved for a future sidelink transmission by the second UE.

16. The method of claim 13 wherein the one or more rules comprise a rule that specifies that the time (c) when the inter-UE coordination message is to be received must be before the time (b) when a collision between a first transmission by the second UE and a second transmission by another UE is expected to occur by at least the processing time (e) for processing the inter-UE coordination message at the second UE.

17. The method of claim 13 wherein the one or more rules comprise a rule that specifies that the time (c) when the inter-UE coordination message is to be received must be after the time (f) at which the message to the first UE was transmitted by at least a sum of the processing time (g) for processing the transmitted message at the first UE and the preparation time (d) for the inter-UE coordination message at the first UE.

18. The method of claim 12 wherein the inter-UE coordination message is to be monitored based on the one or more rules being met.

19. The method of claim 12 wherein the inter-UE coordination message is not to be monitored based on the one or more rules not being met.

20. The method of claim 12 wherein the autonomous resource allocation is Mode 2 resource allocation for New Radio, NR, sidelink transmissions.

21. A first user equipment, UE, configured to:
receive, from a second UE, a message that indicates one or more resources reserved for a future sidelink transmission by the second UE;
determine that a triggering condition for transmission of an inter-UE coordination message is satisfied, based on the received message; and
either transmit the inter-UE coordination message or refrain from transmitting the inter-UE coordination message, based on one or more rules for determining whether to transmit the inter-UE coordination message.

22. (canceled)

23. A second user equipment, UE, configured to:
transmit, to a first UE, a message that indicates one or more resources reserved for a future sidelink transmission by the second UE; and
either monitor for an inter-UE coordination message or refrain from monitoring for the inter-UE coordination message, based on one or more rules for determining whether to monitor for the inter-UE coordination message.

24. (canceled)
